(19) United States
(12) Patent Application Publication
(10) Pub. No.: US 2006/0040111 A1
(43) Pub. Date: Feb. 23, 2006

(54) Process chamber and system for thinning a semiconductor workpiece

(76) Inventors: Kert L. Dolechek, Kalispell, MT (US); Raymon F. Thompson, Kalispell, MT (US)

Correspondence Address: WALLENSTEIN WAGNER & ROCKEY, LTD., 311 SOUTH WACKER DRIVE, 53RD FLOOR, CHICAGO, IL, 60606, US

(21) Appl. No.: 10/922,762

(22) Filed: Aug. 20, 2004

(51) Int. Cl. B32B 13/04; B32B 9/04

(52) U.S. Cl. 428/446

(57) ABSTRACT

The present invention provides a system and method for processing batches of semiconductor wafers or workpieces. The system includes placing a batch of workpieces in a carrier that is loaded into a rotor assembly in a process chamber. The process chamber has a two spray manifolds with a dual inlet ports, and radially opposing vent and drain troughs extending from substantially a first end of a chamber body to substantially the second end of the chamber body. In the process chamber a variety of process fluids are sprayed on the workpieces to process the workpieces.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to a process and apparatus for use with workpieces, such as semiconductor wafers, flat panel displays, rigid disk or optical media, thin film heads or other workpieces formed from a substrate on which microelectronic circuits, data storage elements or layers, or micro-mechanical elements may be formed. These and similar articles are collectively referred to herein as a “wafer” or “workpiece.” More specifically, the present invention relates to a process chamber and system for treating semiconductor workpieces. Such treatment generally relates to the surface preparation, cleaning, rinsing and drying of semiconductor workpieces.

### BACKGROUND OF THE INVENTION

State of the art electronics (e.g., cellular phones, personal digital assistants, and smart cards) demand thinner integrated circuit devices (“ICD”). In addition, advanced packaging of semiconductor devices (e.g., stacked dies or “flip-chips”) provide dimensional packaging constraints which require an ultra-thin die. Moreover, as operating speeds of ICDs continue to increase heat dissipation becomes increasingly important. This is in large part due to the fact that ICDs operated at extremely high speeds tend to generate large amounts of heat. That heat must be removed from the ICD to prevent device failure due to heat stress and to prevent degradation of the frequency response due to a decrease in carrier mobility. One way to enhance thermal transfer away from the ICD, thereby mitigating any deleterious temperature effects, is by thinning the semiconductor wafer from which the ICD is fabricated. Other reasons for thinning the semiconductor wafer include: optimization of signal transmission characteristics; formation of via holes in the die; and minimization of the effects of thermal coefficient of expansion between an individual semiconductor device and a package.

Semiconductor wafer thinning techniques have been developed in response to this ever increasing demand for smaller, higher performance ICDs. Typically, semiconductor devices are thinned while the devices are in wafer form. Conventional wafer thicknesses vary depending on the size of the wafer. For example, the thickness of a 150 mm diameter silicon semiconductor wafer is typically about 650 microns, while wafers having a diameter of 200 or 300 mm are generally about 725 microns thick. Mechanical grinding of the back side of a semiconductor is one standard method of thinning wafers. Such thinning is referred to as “back grinding.” Generally, the back grinding process employs methods to protect the front side or device side of the semiconductor wafer. Conventional methods of protection of the device side include the application of a protective tape or a photoresist layer to the device side of the wafer. The back side of the wafer is then ground until the wafer reaches a desired thickness.

However, conventional back grinding processes have drawbacks. Mechanical grinding induces stress in the surface and edge of the wafer, including micro-cracks and edge chipping. This induced wafer stress can lead to performance degradation and wafer breakage resulting in low yield. In addition, there is a limit to how much a semiconductor wafer can be thinned using a back grinding process. For example, semiconductor wafers having a conventional thickness (as mentioned above) can generally be thinned to a range of approximately 250-150 microns.

Accordingly, it is common to apply a wet chemical etch process to a semiconductor wafer after it has been thinned by back grinding. This process is commonly referred to as polishing. The polishing process relieves the induced stress in the wafer, removes grind marks from the back side of the wafer and results in a relatively uniform wafer thickness. Additionally, polishing after back grinding thins the semiconductor wafer beyond conventional back grinding capabilities. For example, utilizing a wet chemical etch process after back grinding allows standard 200 and 300 mm semiconductor wafers to be thinned to 100 microns or less. Wet chemical etching typically includes exposing the back side of the wafer to an oxidizing agent (e.g., HNO₃, H₃PO₄, H₂SO₄) or alternatively to a caustic solution (e.g., KOH, NaOH, H₂O₂). Examples of wet chemical etching processes may be found in co-pending U.S. patent application Ser. No. 10/631,376, assigned to the assignee of the present invention. The teachings of patent application Ser. No. 10/631,376 are incorporated herein by reference.

Although methods for thinning semiconductor wafers are known, they are not without limitations. For example, mounting a semiconductor wafer to a submount or “chuck” (as it is commonly known) so that the wafer can be thinned requires expensive coating and bonding equipment and materials, increased processing time, and the potential for introducing contaminates into the process area. Additionally, adhesives for bonding a wafer to a chuck that may be useful in a mechanical grinding process will not withstand the chemical process fluids used in wet chemical etching. Furthermore, the current use of a photoresist or adhesive tape fails to provide mechanical support for very thin wafers either during the back grind process or in subsequent handling and processing. The use of tape also creates obstacles in the removal process. For example, tape removal may subject a wafer to unwanted bending stresses. In the case of a photoresist, the material is washed off the device side of a wafer with a solvent, adding to the processing time and use of chemicals, and increasing the risk of contamination.

Further, thinned semiconductor wafers are prone to warping and bowing. And because thinned semiconductor wafers can be extremely brittle, they are also prone to breakage when handled during further processing. Thinned semiconductor wafers (e.g., below 250 microns) also present complications in automated wafer handling because, in general, existing handling equipment has been designed to accommodate standard wafer thicknesses (e.g., 650 microns for 150 mm wafer and 725 microns for 200 and 300 mm wafers).

Accordingly there is a need for a process and equipment for producing thinner semiconductor workpieces. At the same time, there in a need to provide thinner workpieces that are strong enough to be handled by conventional equipment to minimize the threat of breakage. Finally, it would be advantageous to develop a system that reduces the number of processing steps for thinning a semiconductor workpiece.

### SUMMARY OF THE INVENTION

The present invention provides a system and method for use in processing wafers. The system and apparatus includes a process chamber that allows for the batch production of thinner wafers, which at the same time remain strong. As a result, the wafers produced by the present process are less susceptible to breaking, they have a uniform, stress-free surface, and they have a more uniform total thickness variation. The batch processing system also offers improved processing steps and higher productivity since the overall cycle time is reduced. This results in, among other things, improved yields and improved process efficiency.

According to one aspect, one embodiment of the system includes a process chamber that allows for batch wet chemical thinning of semiconductor workpieces down to less than 125 microns. The process chamber comprises a chamber body having a first end, an outer wall, and an opening at the first end leading into a cavity. The process chamber is supported at an incline within the processing machine, and the semiconductor workpieces within the process chamber are similarly supported at an incline therein. A door assembly is provided adjacent the first end of the chamber body. The door assembly has a door that selectively closes the opening of the chamber body. The process chamber also has a spray assembly having a nozzle to spray a process fluid into the cavity of the chamber body and onto the exposed portions of the semiconductor workpieces therein. In one embodiment, the spray assembly has a dual inlet/outlet mechanism that introduces fluid into the process chamber from opposing directions.

According to another aspect, the process chamber has an exhaust vent and a exit port or drain. The exhaust vent exhausts gases and vapors from the cavity of the processing chamber. The drain removes excess and used process fluid from the cavity of the chamber body of the process chamber. The drain may be connected to a recirculation system to deliver the excess and used process fluid from the process chamber to a delivery tank. In a preferred embodiment, both the exhaust vent and the drain traverse about approximately the full length of the process chamber.

According to another aspect, the system includes a carrier assembly to retain a plurality of the workpieces. The carrier assembly is positioned in the cavity of the process chamber, and rotates within the process chamber to allow for better coverage for the sprayed process fluid on the workpieces. In one embodiment, the carrier assembly has a plurality of positioning members about a length of its body. The positioning members are used to retain the semiconductor workpieces in a specific location in the carrier assembly, and to provide a gap between adjacent semiconductor workpieces. Further, because of the geometry of the positioning members of the carrier assembly, the workpieces in the carrier assembly generally rotate both with the carrier assembly, and somewhat independently of the rotation of the carrier assembly.

According to another aspect, the workpieces are positioned in chucks that are placed in the carrier assembly. The chucks cover a peripheral portion of a backside of the workpieces. The chucks leave a majority of the surface area of the backside of the workpiece exposed for processing in the process chamber. In one embodiment, the chucks leave at least 95% of a surface area of the backside of the workpieces exposed.

According to another aspect, the system includes a rotor assembly. The rotor assembly is positioned within the cavity of the process chamber, and the carrier assembly is generally positioned within a cavity of the rotor assembly. A motor associated with the process chamber drives the rotor assembly to rotate the rotor assembly within the cavity of the chamber body. The rotor assembly subsequently provides rotational motion to the carrier assembly and the semiconductor workpieces therein.

According to another aspect, the system includes a delivery tank and a recirculation system. The delivery tank houses a volume of the process fluid and is in fluid communication with the process chamber. The recirculation system is in fluid communication with both an exit port of the process chamber and the delivery tank. The recirculation system communicates used process fluid from the process chamber to the delivery tank.

Several processes for thinning a batch of semiconductor workpieces are also provided. The process includes the step of placing the semiconductor workpieces into a chuck body so that a back side of the workpieces is exposed. Inserting a batch of the workpieces into the carrier assembly. Loading the carrier assembly into a rotor assembly such that the semiconductor pieces are positioned at an incline. Rotating the rotor assembly, which subsequently provides rotational motion to the carrier assembly and the workpieces therein, and spraying a process fluid on the exposed back sides of the workpieces. Through this system the back sides of the workpieces are then thinned to a desired thickness (preferably less than 125 microns). After the workpieces are thinned, the tool and system disclosed provide for rinsing and drying the workpieces. The system also provides for recirculating and recycling used process fluid.

These and other objects, features and advantages of this invention are evident from the following description of preferred embodiments of this invention, with reference to the accompanying drawings.

### BRIEF DESCRIPTION OF THE DRAWINGS

To understand the present invention, it will now be described by way of example, with reference to the accompanying drawings in which:

FIG. 1 is a perspective view of a tool for treating semiconductor workpieces;

FIG. 2 is a perspective view of the tool of FIG. 1, with a panel removed to disclose an inclined work station in the tool;

FIG. 3 is an exploded perspective view of one embodiment of a process chamber used in a work station of the tool of FIG. 1;

FIG. 4 is a perspective view of the workpiece in a retainer prior to being loaded in a work station;

FIG. 5 is a cross-sectional view of the workpiece in the retainer of FIG. 4;

FIG. 6 is an exploded cross-sectional view of the connection between the workpiece and the retainer of FIG. 5;

FIG. 7 is a perspective view of one embodiment of a carrier assembly for use with a process chamber;

FIG. 8 is a side cross-sectional elevation view of the carrier assembly taken about line 8-8 of FIG. 7;

FIG. 9 is a perspective view of another embodiment of a carrier assembly for use with the process chamber of FIG. 3;

FIG. 10 is a front perspective view of the rotor assembly used in the processing system for the workpieces;

FIG. 11 is an exploded rear perspective view of the rotor assembly of FIG. 10;

FIG. 12 is a front perspective view of the process chamber of FIG. 3;

FIG. 13 is a rear perspective view of the process chamber of FIG. 3;

FIG. 14 is a rear cross-sectional view of the process chamber of FIG. 13;

FIG. 15 is a side cross-sectional view, through the vent and drain assemblies, of the process chamber of FIG. 13;

FIG. 16 is a side cross-sectional view, through the spray assembly, of the process chamber of FIG. 13;

FIG. 17 is a flow diagram illustrating a one process for thinning a workpiece in a process chamber;

FIG. 18 is a flow diagram illustrating one process fluid delivery schematic; and,

FIG. 19 is a schematic of a tool incorporating the process chamber of FIG. 3.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

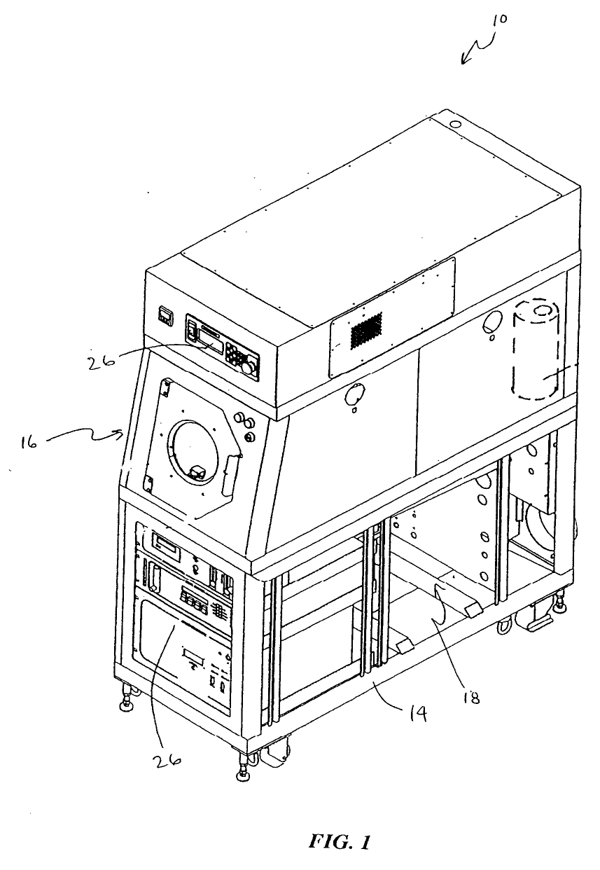

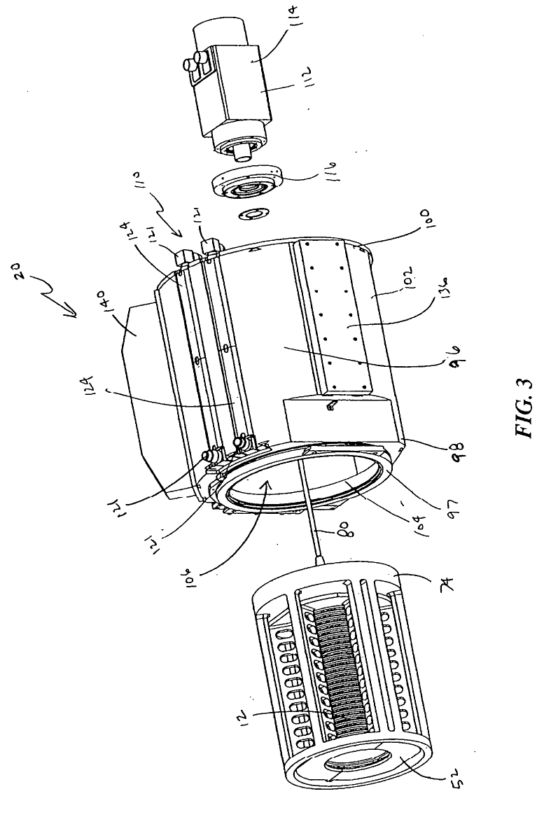

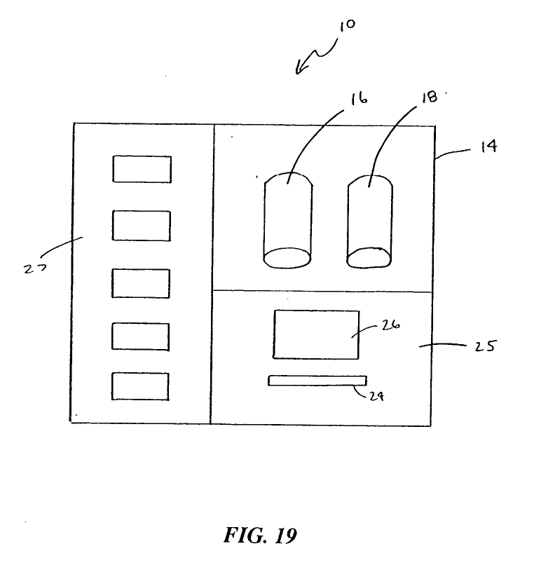

Referring now to the Figures, and specifically to FIGS. 1, 2 and 19, there is shown a machine or tool 10 for processing workpieces 12. The tool 10 preferably includes a cabinet 14 that houses a first processing module 16 and a second processing module 18, however, it is understood that additional work-in-progress pods or modules may also be provided in the tool 10. The first processing module 16 is typically a process chamber to thin the semiconductor workpieces 12, such as the process chamber 20 shown in FIG. 3, and the second processing module 18 is typically a drying and rinsing chamber 22 to dry and rinse the workpieces 12 after they have been thinned. The tool 10 also has electronic control area 25, which is associated with such equipment as a control panel 24, a display 26, and a processor for controlling and monitoring operation of the system. Additionally, the tool 10 has another module 27 which houses the work in process pods. Other features and components of the system will be described in detail herein.

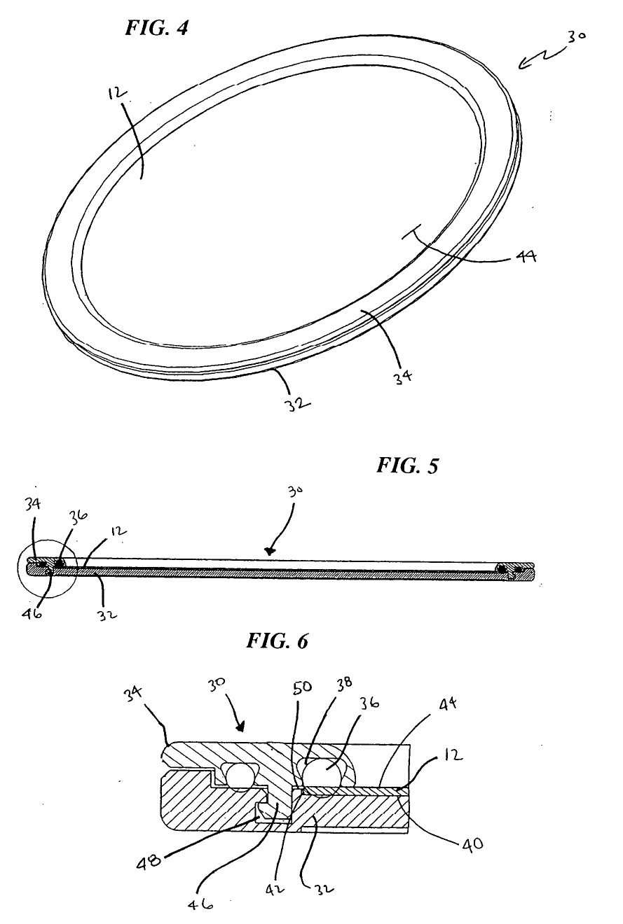

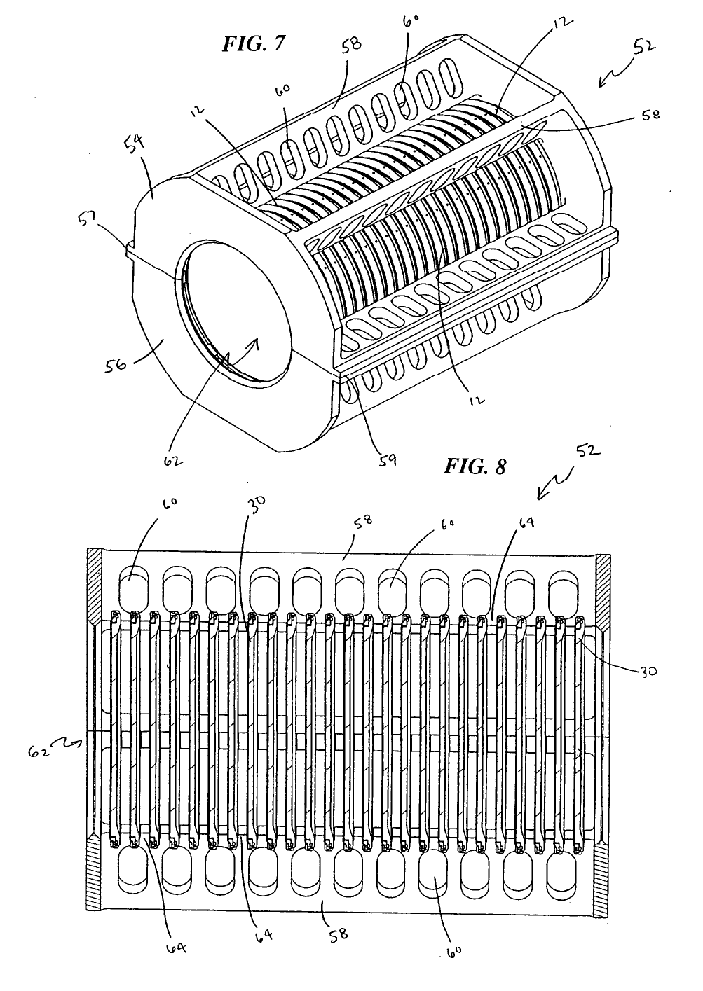

As explained above, in the present system a plurality of workpieces 12 is thinned in the process chamber 20. In a preferred embodiment, prior to being placed in the process chamber 20 the workpiece 12 is mounted in a chuck 30 for processing. As shown in FIGS. 4-6, the chuck 30 is comprised of a supporting body 32, a retainer 34 and a sealing member 36. The retainer 34 has at least one annular groove or recess 38 in which the sealing member 36 is disposed. The retainer 34 is preferably in the form of a ring and is removably attached to the supporting body 32. In use, a single workpiece 12, which has a device side 40, a peripheral edge 42 and a back side 44, is placed onto the supporting body 32 of chuck 30 with the device side 40 down. The retainer 34 is then attached to the supporting body 32. As shown specifically in FIGS. 5 and 6, when the retainer 34 is engaged to the supporting body 32, the retainer 34 covers a peripheral portion of the back side 44 of the workpiece 12, leaving a majority of the back side 44 of the workpiece 12 exposed. In a preferred embodiment, the chuck 30 leaves at least 95% of the surface area of the backside of the workpiece 12 exposed. The exposed portion of the back side 44 of a plurality of workpieces 12 is then subjected to a process fluid and thinned to a desired thickness as explained below.

As best shown in FIGS. 5 and 6, in order to facilitate attachment to the supporting body 32, the retainer 34 has an engagement member 46 that cooperates with a recess 48 formed in the supporting body 32. In this manner, the retainer 34 is removably engaged to the supporting body 32. Additionally, the supporting body 32 has a supporting surface 48 and a lip or step 50 formed circumferentially in the supporting surface 48 to register or accept the workpiece 12 as it is loaded into the chuck 30.

The chuck 30 can be made from a number of different polymer materials that are stable and highly chemically resistant. The supporting body 32 preferably comprises polytetrafluoroethylene, and the retainer 34 preferably comprises a fluoropolymer such as polyvinylidene fluoride sold by Atofina Chemicals under the KYNAR tradename. In order to enhance the attachability of the retainer 34 to the supporting body 32 it is preferred that the supporting body 32 is comprised of a material having a Durometer hardness greater than the Durometer hardness of the material from which the retainer 34 is formed. Additionally, while the chuck 30 can be any shape (e.g., square, rectangular, circular, etc), in a preferred embodiment the chuck is disk-shaped and will have a diameter slightly larger than the diameter of the workpiece 12 to be processed.

Referring now to FIGS. 7-8, there is shown a first embodiment of a carrier assembly 52 for retaining a plurality of workpieces 12. The carrier assembly 52 generally retains the workpieces 12 about a peripheral portion thereof. In this embodiment, the carrier assembly 52 comprises a first carrier member 54 and a second carrier member 56 that connect to form the overall carrier assembly 52. Approximately 25 workpieces 12 can be retained within this carrier assembly 52. Each carrier member 54, 56 have a plurality of support legs 58 to provide rigidity to the carrier assembly 52. In a preferred embodiment, as shown in FIG. 7, each carrier member 54, 56 has four radially extending and generally equally spaced support legs 58. The spacing between the support legs 58 allows the process fluid to reach the workpieces 12 in the process chamber 20. Further, the support legs 58 have a plurality of apertures 60 therethrough to reduce the weight of the carrier members 54, 56. As shown in FIG. 7, when the first and second carrier members 54, 56 are joined, first and second engaging members 57, 59 extend from the carrier assembly 52. The engaging members 57, 59 mate with the rotor assembly 74 (explained below) to positionally retain the carrier assembly 52 within the rotor assembly 74.

The carrier assembly 52 has a central bore area 62. At a perimeter of the central bore area 62 the carrier assembly 52 has a plurality of positioning members 64 which position and retain the semiconductor workpieces 12 within the carrier assembly 52. The positioning members 64 generally extend radially inward from the support legs 58. Thus, the positioning members 64 provide a gap between adjacent workpieces 12 in the carrier assembly 52 to allow the process fluid to interact with the entire backside of the workpieces 12. As best shown in FIG. 8, the positioning members 64 assist in retaining the workpieces 12, which are mounted in the chucks 30 as explained above, on-edge in the carrier assembly 52. Notwithstanding, the geometry of the positioning members 64 generally allows the workpieces 12 slight free movement both axially and rotationally when positioned in the carrier assembly 52. Thus, the workpieces 12 are able to somewhat independently rotate within the carrier assembly 52. The carrier assembly 52 is typically made of polytetrafluoroethylene or stainless steel. In a preferred embodiment, it is made of polytetrafluoroethylene.

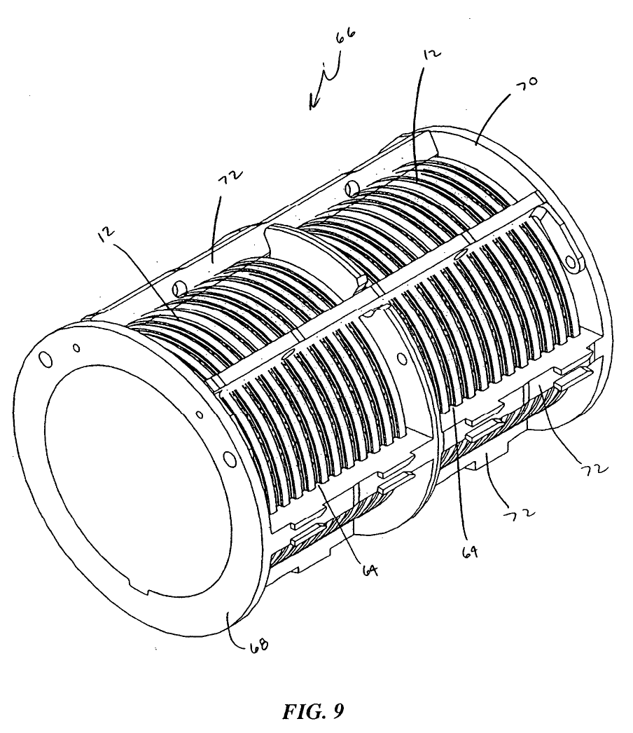

Another carrier assembly 66 is shown in FIG. 9. In this embodiment, the carrier assembly 66 has a first end plate 68, a second end plate 70 and a plurality of linking members 72 extending between the first end plate 68 to the second end plate 70. At least one of the linking members 72 has positioning members 64 depending therefrom and extending radially inward to position and retain the workpieces 12 within the carrier assembly 66. As in the carrier assembly 52 described above, the positioning members 64 in this carrier assembly 66 assist in retaining the workpieces 12, secured in the chucks 30, on-edge in the carrier assembly 68. Further, as in the carrier assembly described above, the positioning members 64 allow the workpieces 12 slight free movement both axially and rotationally when positioned in the carrier assembly 66. The carrier assemblies 52, 66 may be used to process workpieces 12 of various sizes, however they are typically configured to process workpieces 12 of one size, such as 200 mm or 300 mm diameter semiconductor wafers.

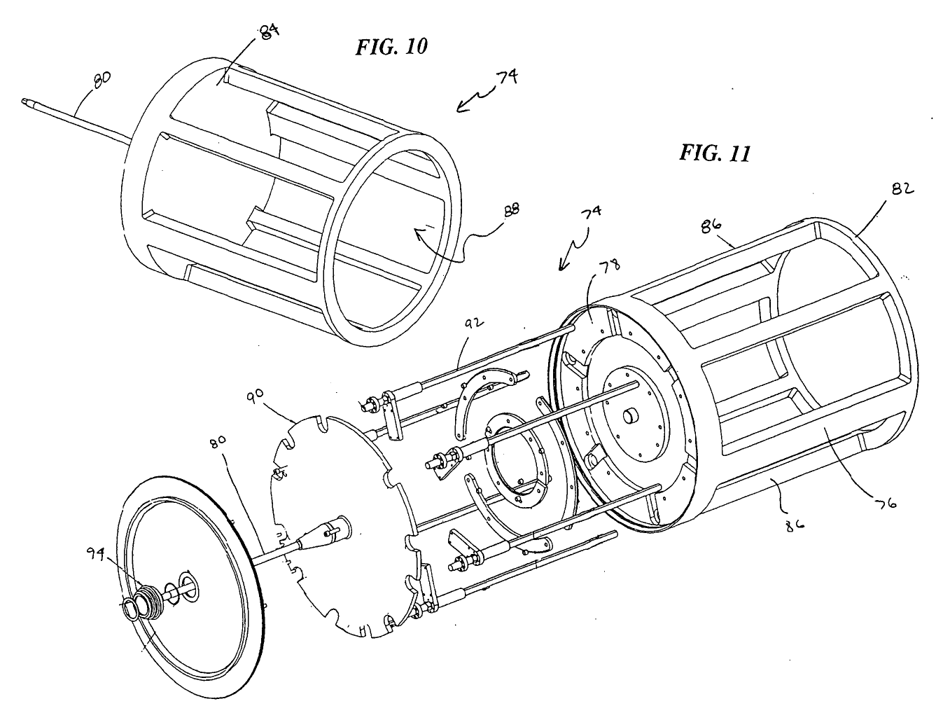

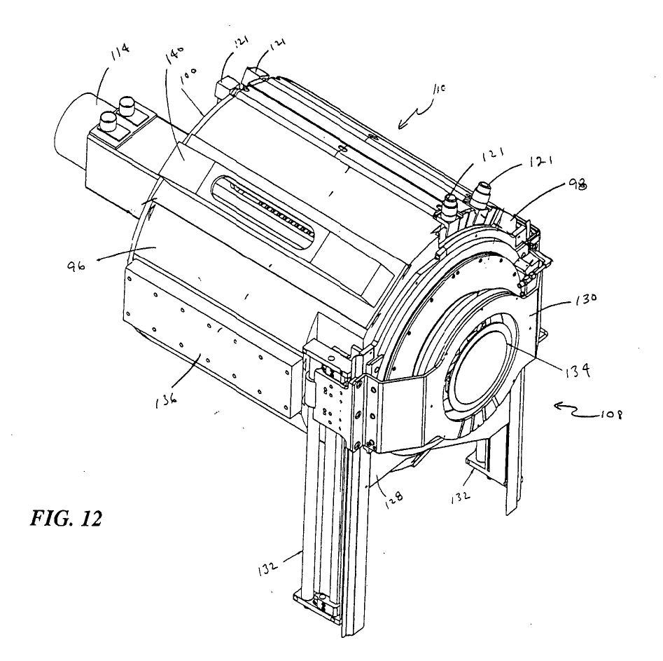

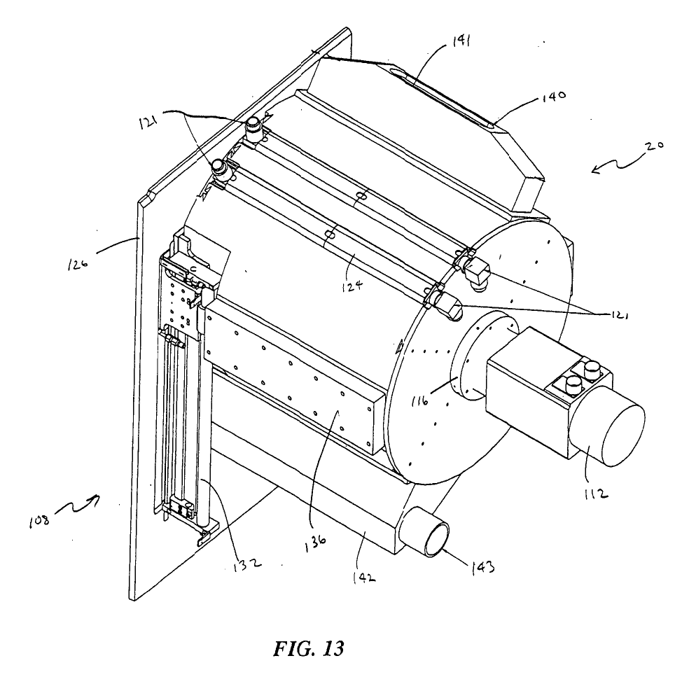

After the appropriate carrier assembly (for purposes of example, this disclosure will utilize carrier assembly 52 in further discussions herein) is loaded with the workpieces 12, it is fitted into a rotor assembly 74 contained in the cavity 106 of the process chamber 20. An example of a rotor assembly 74 is shown in FIGS. 10 and 11, and an example of a rotor assembly 74 loaded with a carrier assembly 52 is shown in FIG. 3. The rotor assembly 74 generally comprises a generally cylindrical rotor 76, a generally circular base plate 78 and a drive shaft 80. The rotor 76 has an exterior ring 82, a base 84, and a plurality of connecting members 86 extending between the base 84 and the exterior ring 82. A cavity 88 is defined between the interior of the base 84, connecting members 86 and exterior ring 82. The cavity 88 is shaped to accept the carrier assembly 52. The drive shaft 80 is connected to a drive plate 90 and rotates with the drive shaft 80. In turn, a plurality of auxiliary drive rods 92 are connected to the drive plate 90. The drive rods 92 extend through the connecting members 86 to assist in driving the rotor assembly 74. Typically, the rotor 76 is made of a polytetrafluoroethylene, however, other materials are acceptable. Additionally, in order to maintain sufficient rigidity, but to reduce the weight, the auxiliary drive rods 92 are made of carbon graphite. The drive shaft 80 and drive plate 90 are typically made of stainless steel, or some other appropriate material. A seal 94 is utilized to ensure that the process fluid does not enter into the internal components of the rotor assembly 74.

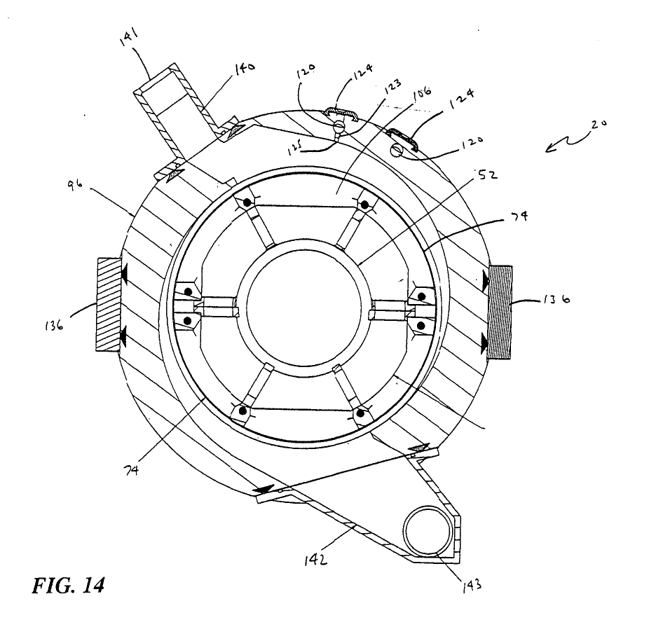

Referring to FIGS. 3 and 14, the carrier assembly 52 is loaded into the rotor assembly 74 in a cavity 106 of the process chamber 20. The process chamber 20 comprises a chamber body 96 having a first end 98, a second end 100, an outer wall 102, and an opening 104 at the first end 98 of the chamber body 96 leading into the cavity 106 of the process chamber 20. The cavity 106 is shaped to contain a rotor assembly 74 that is to be filled with a carrier assembly 52 loaded with a plurality of workpieces 12. The chamber body 96 may have a split ring assembly 97 which connects to the first end 98 of the chamber body 96. In a preferred embodiment, the chamber body 96 is made of a substantially thick, i.e., approximately 25 mm. thick, polytetrafluoroethylene. This material is substantially inert to various corrosive and caustic etchants that are used in the etching/thinning process. It is understood, however, that other materials which provide similar qualities may also be utilized for the liner. Alternatively, the process chamber 20 may have a liner 107 which is made of such materials.

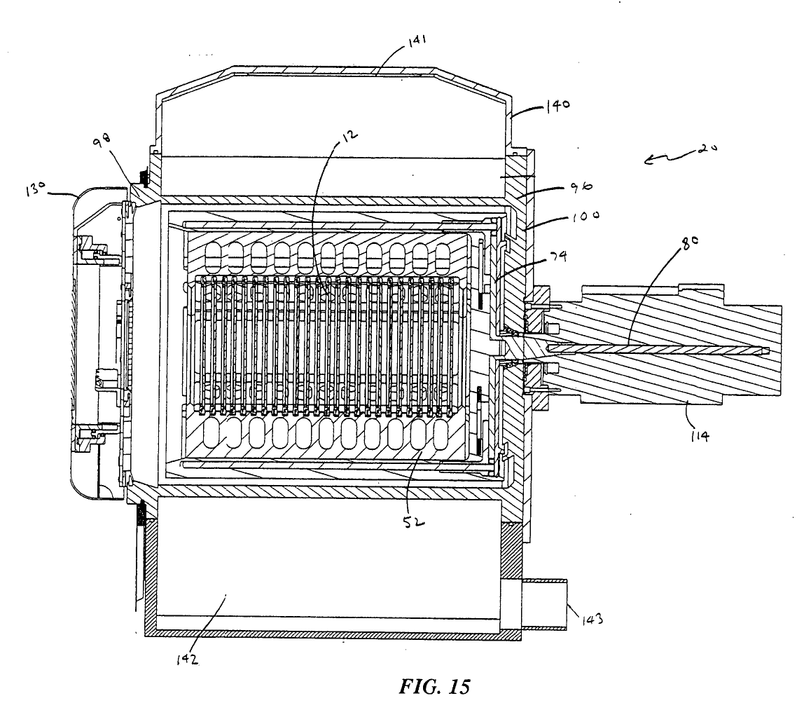

The process chamber 20 also has various assemblies connected thereto, including a door assembly 108 and a motor assembly 112. As shown in FIGS. 3 and 13, the motor assembly 112 generally comprises a motor 114 and a mounting plate 116. The motor 114 is connected to the mounting plate 116, and the mounting plate 116 is in turn connected to the second end 100 of the chamber body 96 of the process chamber 20. In a preferred embodiment, the motor 112 comprises a brushless D.C. servo motor. As shown in FIG. 15, the drive shaft 80 of the rotor assembly 74 extends out of the process chamber 20 and through an aperture 118 in the second end 100 of the chamber body 96. The drive shaft 80 is inserted into the motor 114 to allow the motor 114 to drive, i.e., provide rotational motion to, the drive shaft 80. Accordingly, through the drive shaft 80 of the rotor assembly 74, the motor 114 is able to rotate the carrier assembly 52 and the workpieces 12 therein.

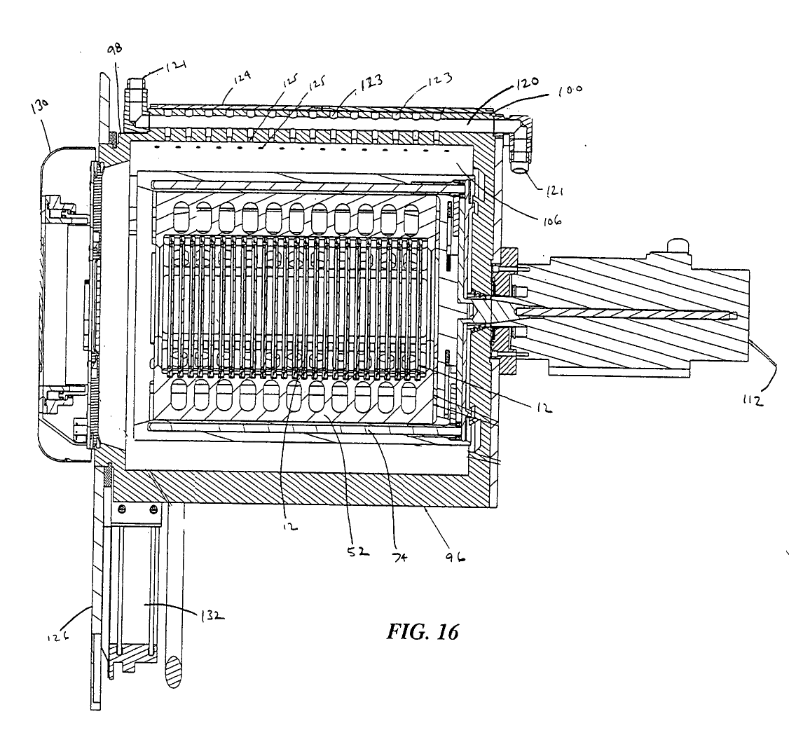

The process chamber 20 also includes a spray assembly 110 to inject process fluid into the process chamber. In a preferred embodiment, the spray assembly 110 is integral with the process chamber 20. In a preferred embodiment as shown in FIGS. 3 and 12-16, the spray assembly 110 has a pair of dual, overlapping spray manifolds 120 to provide more uniform delivery of the process fluid. Each of the manifolds 120 has two inlet ports 121, a plurality of nozzles 122 positioned in nozzle receptacles 123, and a plurality of openings 125 through which the processing fluid is sprayed into the process chamber 20 from the nozzles 122. The manifolds 120 receive the process fluid at the inlet port 121 from a delivery tank 146, and distribute the process fluids along the length of the manifold 120 to a plurality of nozzles 122 as shown in FIG. 16. A nozzle retainer 124 covers the nozzles 122. The nozzles 122 spray the process fluid into the cavity 106 of the process chamber 20 and onto the exposed portion of the workpieces in the carrier assembly 52 as they are rotated by the rotor assembly 74.

In a preferred embodiment, each of the manifolds 120 have inlet ports 121 at both the first end 98 and the second end 100 of the process chamber 20, and nozzles 122 extending substantially along the entire length of the process chamber 20. This provides for a dual inlet of process fluid in opposing directions about the manifold 120. By having a dual inlet of the process fluid in the manifolds 120, the pressure drop across the manifold 120 is decreased and the amount of flow or volume of fluid able to be introduced into the process chamber 20 is increased.

Referring to FIG. 12, the door assembly 108 extends adjacent the first end 98 of the chamber body 96 to provide access into the cavity 106 of the process chamber 20. The door assembly 108 preferably forms a seal with the first end 98 of the process chamber 20. As shown in FIGS. 12, the door assembly 108 generally comprises a support plate 126, a front panel plate 128, a door 130 and a pair of linear tracks or guides 132. In a preferred embodiment, the liner tracks 132 comprise linear actuators. The support plate 126 is connected to the chamber body 96 to fix the door assembly 108 to the process chamber 20. The front panel plate 128 extends below the support plate 126 and provides a support for a lower end of the linear actuators 132. The linear actuators 132 support the door 130 and provide for moving the door 130 from a first position, wherein the door 130 sealingly closes the opening 104 to the cavity 106 of the chamber body 96, to a second position (as shown in FIG. 12) wherein the cavity 106 is accessible. The door 130 may also have a window 134 for allowing visual inspection into the process chamber 20.

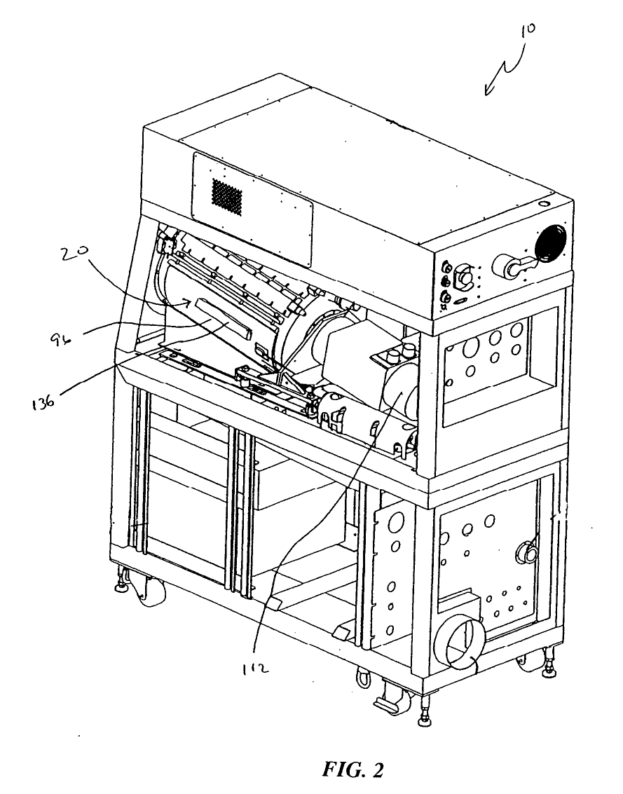

As best shown in FIG. 2, the process chamber 20 is generally fixed within the cabinet 14 of the machine 10 at an inclined angle. In a preferred embodiment, the process chamber 20 has mounting members 136 on the sides of the chamber body 96. The mounting members 136 mate with receivers (not shown) in the machine 10 to support the process chamber 20. In this embodiment, the mounting members 136 operate as male-type mating members, and the receivers operate as female-type mating members. It is understood, however, that other types of mounting is possible without departing from the scope of the present invention, including that the mounting members 136 on the chamber body 96 may be of the female type, and the receiving members in the machine 10 may be of the male type.

While the process chamber 20 may be oriented horizontally, it is preferably orientated at an inclined angle. Moreover, in a preferred embodiment, the first end 98 of the chamber body 96 is inclined upwardly at an angle of, for example, 5 to 30°, and most preferably about 10°, so that the first end 98 of the process chamber 20 is at a higher elevation than the second end 100 of the processing chamber 20. To accomplish such an orientation, in a preferred embodiment the receiving members in the cabinet 14 are provided at the appropriate angle of inclination. The chamber body 96 of the process chamber 20 is connected to the receiving members via the mounting members 136 as described above. It is understood that the semiconductor workpieces are thus positioned at approximately the same angle of inclination as the process chamber 20.

As shown in FIGS. 13-15, the process chamber 20 has an exhaust vent 140 and a exit port or drain 142. The exhaust vent 140 exhausts gases and vapors from the cavity 106 of the processing chamber 20 and out a vent outlet 141. In a preferred embodiment, the exhaust vent 140 extends about substantially the entire length of the chamber body 96. The drain 142 comprises a drain trough that similarly extends about substantially the entire length of the chamber body 96 in a preferred embodiment to drain spent process fluid and removed silicon down and out of the process chamber 20. As shown in FIG. 14, the vent 140 may be located in an opposing portion of the chamber body as the drain 142. The drain 142 has a drain outlet 143 that is connected to a recirculation system 144 to drain the excess and used process fluid and silicon from the cavity 106 of the chamber body 96 of the process chamber 20. The recirculation system 144 typically delivers the excess and used process fluid from the process chamber to the appropriate delivery tank 146. Additionally, the process fluids and removed silicon may be drained out of the process chamber 20 and discarded instead of being recirculated. The vent 140 and the drain 142 are configured to provided remove the excess/used process fluid and fumes from the process chamber in a single pass. The fumes vent upward out the exhaust vent 140, and the spent process fluid and silicon are drained downward and out the drain 142.

In a preferred embodiment, the process fluid utilized in the current system comprises one or more of: water, hydrogen peroxide, ozone, potassium hydroxide, sodium hydroxide, hydrofluoric acid, nitric acid, sulfuric acid, acidic acid and phosphoric acid. Other process fluids are also possible. The process fluid can be mixed and adjusted to address the specific needs of the system.

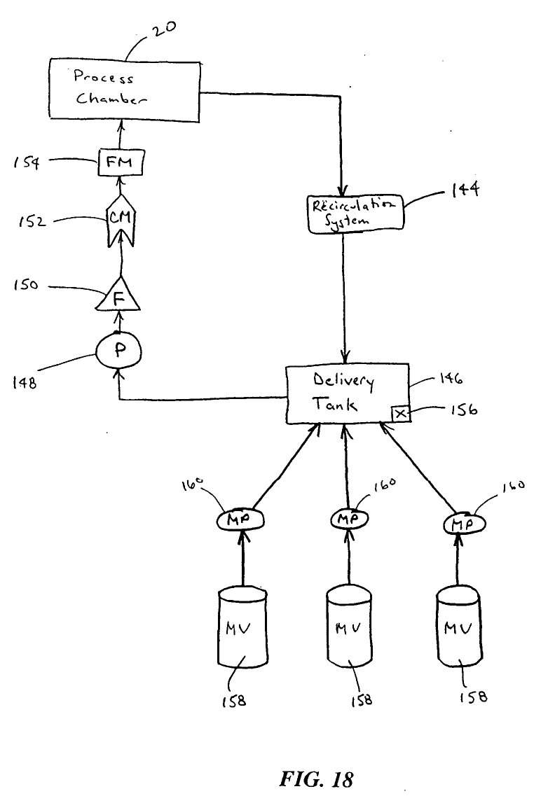

A volume of the process fluid is typically housed in the delivery tank 146 for delivery to the process chamber 20. Additional components, however, may be provided as part of an overall system in delivering fluids from the delivery tank 146 to the process chamber 20. An example of a fluid delivery schematic is shown in FIG. 18. In that example, a pump 148 is used to pump the process fluid from the delivery tank 146 to the process chamber 20. A filter 150 is provided between the delivery tank 146 and the process chamber 20 to filter the process fluid. Additionally, a concentration monitor 152 may be provided between the delivery tank 146 and the process chamber 20 to monitor the concentration of the process fluid being delivered to the process chamber 20. Finally, a flow meter 154 is utilized to monitor the volume of process fluid delivered to the process chamber 20. A heat exchanger 156 may also be provided in connection with the delivery tank 146 to regulate the temperature of the process fluid therein. These components are typically housed in the overall tool 10.

The system may also include concentrated metering vessels 158 that contain concentrated volumes of the various processing fluids. For example, as shown in FIG. 18, three metering vessels 158 are provided. In this example one metering vessel contains hydrofluoric acid, another metering vessel contains nitric acid, and another metering vessel contains phosphoric acid. Each metering vessel 158 typically has its own metering pump 160 to deliver a specific process fluid from the metering vessel 158 to the delivery tank 146. Depending on the concentration of the process fluid, usually determined by the concentration monitor 152, one or more of the metering pumps 160 may dose the bath of process fluid in the appropriate delivery tank 146 to maintain the required concentration of fluid therein. The metering vessels 158 may be housed within the tool 10, or they may be housed outside the tool and the fluid merely pumped to via the metering pumps 160 into the tool 10.

As explained below in the method for processing the workpieces, various cleaning and etching steps are provided. For each step, a separate delivery tank 146 is typically provided. Accordingly, the processing fluid necessary for the pre-cleaning step 212 may be housed in one delivery tank 146, the processing fluid necessary for the coarse etching step 214 may be housed in a separate delivery tank 146, the processing fluid necessary for the polish etching step 216 may be housed in another separate delivery tank 146, and the processing fluid necessary for the rinsing step 218 may be housed in yet another separate delivery tank 146. The metering vessels 158 may therefore be utilized to separately deliver fluid to the appropriate delivery tank 146 (only one delivery tank is shown in FIG. 18). Additionally, the recirculation system delivers the excess and used process fluid from the process chamber to the appropriate delivery tank 146 depending on the current process step.

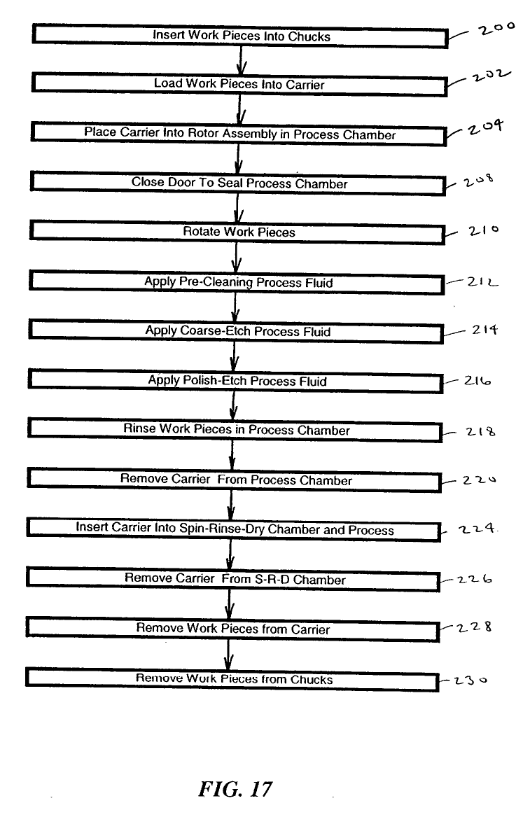

One method for processing a batch of semiconductor workpieces is illustrated in FIG. 17. As illustrated therein, the first step 200 that is usually performed in processing the workpieces is to place the workpieces 12 in chucks 30 with the back side of the workpiece 12 exposed. The second step 202 includes loading the workpieces 12 (already in the chucks 30) into the carrier assembly 52 between the positioning members of the carrier assembly. After the carrier assembly 52 is fully loaded with a plurality of workpieces 12, typically 25 to 50 workpieces, the carrier assembly 52 is placed in the rotor assembly 74 within the cavity 106 of the process chamber 20 in step 204. After the workpieces 12 are loaded into the rotor assembly 74 in the process chamber 20, the door 130 is moved to the first position to sealingly close the opening 104 to the cavity 106 of the chamber body 96 (step 208).

After the workpieces 12 are placed in the cavity 106 and the door 130 to the process chamber 20 is closed, the workpieces are prepared to be processed. Typically, the workpieces 12 are processed while rotating in the process chamber 20. Accordingly, at step 210, the motor 114 is charged to rotate the rotor assembly 74 within the process chamber 20. The workpieces 12 rotate with the carrier assembly 52 in the rotor assembly 74, however, the workpieces 12 also somewhat independently rotate and move axially as explained above. Next, process fluid is sprayed through the nozzles 122 of the spray assembly 110 onto the exposed portion of the workpieces in the carrier assembly 52 as they are rotated by the rotor assembly 74.

In one embodiment, a first pre-cleaning spray step (step 212) is performed. In this step 212, a cleaning fluid is sprayed through the spray assembly 110 and onto the exposed portion of the workpieces 12 in the process chamber 20 to remove surface contamination on the workpieces 12. The cleaning solution is housed in a first delivery tank and may comprise at least one of H₂O, H₂O₂ and NH₄OH. Next, a first coarse chemical etch is performed at step 214. In the first chemical etch step, an increased etch rate is utilized to remove larger quantities of the substrate from the workpiece 12. After the coarse chemical etch is performed on the workpieces 12, a polish chemical etch is performed on the workpieces 12 at step 216. The etch rate of the polish chemical etch is less than the etch rate of the coarse chemical etch. In a preferred embodiment, the step of chemically etching the workpieces 12 comprises applying a solution of HF, HNO₃ and H₃PO₄ to the workpieces 12. Two different delivery tanks are used to house the fluid for the coarse and polish etching processes. Through these two steps the batch of workpieces 12 are thinned in the process chamber 20. The workpieces 12 may be thinned to a thickness of less than 100 microns. Next, the workpieces 12 are rinsed in the process chamber at step 218. Rinsing the workpieces 12 generally comprises applying a solution of H₃PO₄ to the workpieces 12 in the process chamber 20. This solution is housed in yet another delivery tank 146. During each of these steps, the used process fluid is typically reclaimed via the recirculation system 144, and delivered from the process chamber 20 to the appropriate delivery tank 146.

After the workpieces 12 have been thinned and rinsed, they are typically removed from the process chamber 20 at step 220. Generally, the workpieces 12 remain in the carrier assembly 52, and the carrier assembly 52 is removed from the rotor assembly 74 in the process chamber 20. At step 224, the carrier assembly 52, holding the workpieces 12, is placed in the secondary processing module 18 for drying and rinsing thereof. The step of drying and rinsing the workpieces 12 in the drying and rinsing chamber 22 generally comprises first applying deionized water to the workpieces 12 to rinse the workpieces 12, and then applying isopropylalcohol vapor or hot nitrogen gas to the workpieces to dry the workpieces 12, all while spinning the workpieces 12. Each of these fluids may be held in yet another delivery tank.

After the workpieces 12 have been cleaned and dried, the carrier assembly 52 is removed from the secondary process chamber 22 at step 226. At step 228 the workpieces 12 are removed from the carrier assembly 52, and finally at step 230 the workpieces 12 are removed from the chucks 30.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A process chamber for processing a plurality of semiconductor workpieces, the process chamber comprising:
a chamber body having a first end, a second end, an outer wall, and an opening at the first end leading into a cavity, wherein a carrier retaining a plurality of workpieces is removably positioned within the cavity of the chamber;
a door assembly adjacent the first end of the chamber body, the door assembly having a door that closes the opening of the chamber body;
a motor connected to the chamber body to rotate the carrier within the cavity of the chamber body, and;
a spray assembly having a nozzle to spray a process fluid into the cavity of the chamber body and onto exposed portions of the plurality of workpieces in the carrier;
a vent in the chamber body to vent vapors from the cavity of the process chamber, the vent extending from proximal the first end to proximal the second end of the chamber body; and,
an drain trough in the chamber body, the drain trough extending from proximal the first end to proximal the second end of the chamber body to drain process fluid from the cavity of the chamber body.

2. The process chamber of claim 1, wherein the vent and the drain trough are provided in radially opposing areas of the chamber body.

3. The process chamber of claim 1, further comprising a rotor assembly positioned within the cavity of the chamber body, the carrier being positioned within the rotor assembly, and wherein the motor drives the rotor assembly to rotate the rotor assembly within the chamber body, the rotor assembly providing rotational motion to the carrier and the plurality of workpieces therein.

4. The process chamber of claim 1, wherein the carrier has a plurality of positioning members retaining the workpieces on edge in the carrier, the positioning members providing a gap between adjacent workpieces.

5. The process chamber of claim 4, wherein the workpieces are free to independently rotate within the carrier.

6. The process chamber of claim 1, wherein the housing has a liner in the cavity thereof, the liner being made of at least one of polytetrafluoroethylene or stainless steel.

7. The process chamber of claim 1, wherein the spray assembly extends from generally adjacent the first end of the chamber body to a distance proximal the second end of the chamber body.

8. The process chamber of claim 1, wherein the spray assembly comprises a spray manifold having a plurality of nozzles.

9. The process chamber of claim 8, wherein the spray manifold has two inlet ports.

10. The process chamber of claim 9, wherein the inlet ports are provided at opposing ends of the spray manifold.

11. The process chamber of claim 1, wherein the spray assembly comprises a first spray manifold having a plurality of nozzles, and a second spray manifold having a plurality of nozzles.

12. The process chamber of claim 11, wherein the first spray manifold has two inlet ports, and wherein the second spray manifold has two inlet ports.

13. The process chamber of claim 1, further comprising mounting members connected to the chamber body to secure the chamber body and the workpieces therein at an incline.

14. The process chamber of claim 1, wherein the door moves from a first position to a second position, the door sealingly closing the opening of the cavity of the chamber body in the first position, and the cavity being accessible through the opening when the door is in the second position.

15. The process chamber of claim 14, further comprising a linear track supporting the door, the door moving from the first position to the second position about the linear track.

16. A process chamber for processing a plurality of semiconductor workpieces, the process chamber comprising:
a chamber body having a first end, a second end, an outer wall, and an opening at the first end leading into a cavity, wherein a carrier retaining a plurality of workpieces is removably positioned within the cavity of the chamber;
a door assembly adjacent the first end of the chamber body, the door assembly having a door that closes the opening of the chamber body;
a motor connected to the chamber body to rotate the carrier within the cavity of the chamber body, and;
a spray assembly having a manifold and a plurality of nozzles in communication therewith to spray a process fluid into the cavity of the chamber body and onto exposed portions of the plurality of workpieces in the carrier, the manifold having a first inlet port and an opposing second inlet port to provide fluid into the manifold.

17. The process chamber of claim 16, wherein the first inlet port is at a first end of the manifold, and wherein the second inlet port is at a second end of the manifold.

18. The process chamber of claim 16, further comprising a second manifold having a plurality of nozzles in communication therewith, the second manifold having a first inlet port and an opposing second inlet port.

19. The process chamber of claim 18, wherein the first inlet port for the second manifold is positioned at a first end of the second manifold, and wherein a second inlet port for the second manifold is positioned at a second end of the second manifold.

20. A tool for thinning a plurality of semiconductor workpieces, the tool comprising:
a cabinet;
a process chamber in the cabinet, the process chamber comprising:
a chamber body having a first end, a second end, an outer wall, an opening at the first end leading into a cavity, a vent in the chamber body to vent vapors from the cavity, and a drain trough in the chamber body to drain the process fluid from the cavity;
a door assembly connected to the chamber body adjacent the first end of the chamber body, the door assembly having a door that closes the opening of the chamber body; and,
a spray assembly having a manifold in association with a plurality of nozzles to spray a process fluid into the cavity of the chamber body and onto the semiconductor workpieces;
a delivery tank in fluid communication with the process chamber, wherein the delivery tank retains a volume of the process fluid, and wherein the process fluid is delivered from the delivery tank to the spray assembly of the process chamber; and,
a recirculation system fluidly connected between the exit port of the process chamber and the delivery tank to communicate used process fluid from the process chamber to the delivery tank.

21. The tool of claim 20, wherein the vent extends from substantially the first end to the second end of the chamber body, and wherein the drain trough in extends from substantially the first end to the second end of the chamber body to drain process fluid from the cavity of the chamber body.

22. The tool of claim 20, wherein the spray assembly extends from generally proximal the first end of the chamber body to a distance proximal the second end of the chamber body.

23. The tool of claim 20, wherein the manifold has two inlet ports.

24. The tool of claim 23, wherein the inlet ports are provided at opposing ends of the manifold.

25. The tool of claim 20, wherein the spray assembly comprises a first manifold having a plurality of nozzles, and a second manifold having a plurality of nozzles.

26. The tool of claim 25, wherein the first manifold has two opposing inlet ports, and wherein the second manifold has two opposing inlet ports.

27. The tool of claim 20, further comprising a carrier retaining a plurality of the workpieces, the carrier being removably located within a rotor assembly positioned within the cavity of the chamber body, and wherein the motor drives the rotor assembly to rotate the rotor assembly within the chamber body, the rotor assembly providing rotational motion to the carrier and semiconductor workpieces therein.

28. The process chamber of claim 27, wherein the carrier has a plurality of positioning members retaining the semiconductor workpieces on edge in the carrier, the positioning members providing a gap between adjacent semiconductor workpieces to allow the workpieces to independently rotate within the carrier.

29. The tool of claim 20, wherein the delivery tank has a heat exchanger coil to regulate the temperature of the processing fluid in the delivery tank.

30. The tool of claim 20, further comprising a mounting member of the chamber body mating with a receiver in the cabinet to support the chamber body at an incline within the cabinet.

31. The tool of claim 20, further comprising a plurality of metering vessels in fluid communication with the processing chamber, the metering vessels containing processing fluid for use in the processing chamber to thin the semiconductor workpiece.

32. The tool of claim 31, further comprising a metering pump for each metering vessel to selectively dose the processing fluid in the delivery tank to maintain an appropriate concentration of chemicals therein.

33. The tool of claim 20, further comprising a pump, a filter and a flow meter between the delivery tank and the process chamber, wherein the pump assists in delivering processing fluid from the delivery tank to process chamber, wherein the filter filters the processing fluid transferred to the process chamber, and wherein the flow meter measures the amount of processing fluid being delivered to the process chamber.

34. The tool of claim 33, further comprising a concentration monitor between the delivery tank and the process chamber to determine the concentration of fluids in the processing fluid delivered to the process chamber.

35. The tool of claim 20, further comprising a secondary process chamber in the cabinet.

36. The tool of claim 20, further comprising a drying and rinsing chamber within the cabinet to dry and rinse the workpiece after it has been thinned.

37. A method for simultaneously processing a plurality of semiconductor workpieces, comprising the steps of:
placing a plurality of workpieces in a carrier;
loading the carrier in a process chamber, the process chamber comprising:
a chamber body having a first end, a second end, an outer wall, and an opening at the first end leading into a cavity;
a door assembly connected to the chamber body adjacent the first end of the chamber body, the door assembly having a door that moves from a first position whereby the door closes the opening to the cavity of the chamber body, to a second position whereby the opening to the cavity of the chamber body is accessible; and,
a spray assembly having a manifold in communication with a plurality of nozzles to spray a process fluid into the cavity of the chamber body, the manifold having a first inlet port and a second opposing inlet port for receiving the process fluid;
rotating the carrier in the cavity of the process chamber; and,
spraying a process fluid from through the nozzles and on an exposed portion of the workpieces in the carrier.

38. The method of claim 37, wherein the carrier has a plurality of positioning members, wherein the workpieces are inserted into the carrier on-edge between the positioning members.

39. The method of claim 37, wherein the retainers for the workpieces comprise chucks, and further comprising the steps of:
placing the chucks in the carrier and between positioning members thereof.

40. The method of claim 39, wherein the chucks cover a peripheral portion of a backside the workpieces, leaving at least 95% of a surface area of the backside of the workpieces exposed.

41. The method of claim 37, further comprising the steps of:
placing the carrier in a rotor assembly in the process chamber, the process chamber having a motor; and,
powering the motor to rotate the rotor assembly in the process chamber.

42. The method of claim 37, wherein the carrier is made at least partially of polytetrafluoroethylene.

43. The method of claim 37, further comprising the step of simultaneously venting and draining the cavity of the process chamber, the process chamber having a vent that extends from proximal the first end of the chamber body to proximal the second end of the chamber body, and the process chamber having a drain trough that extends from proximal the first end of the chamber body to proximal the second end of the chamber body.

44. The method of claim 37, further comprising the steps of rinsing and drying the workpieces after they have been thinned.

45. The method of claim 44, wherein the step of rinsing the workpieces comprises applying deionized water to the workpieces.

46. The method of claim 44, wherein the step of drying the workpieces comprises applying at least one of isopropylalcohol or heated nitrogen to the workpieces.

47. The method of claim 37, wherein the step of spraying a process fluid on the workpieces comprises spraying a process fluid on the workpieces through a plurality of nozzles of the spray assembly when the workpieces are rotated in the process chamber.

48. The method of claim 47, wherein the process fluid is a selected from the group consisting of water, hydrogen peroxide, ozone, potassium hydroxide, sodium hydroxide, hydrofluoric acid, nitric acid, sulfuric acid, acidic acid and phosphoric acid.

49. The method of claim 47, further comprising the step of reclaiming used process fluid from within the process chamber.

50. The method of claim 37, wherein the step of spraying a process fluid from the spray assembly on an exposed portion of the workpieces in the carrier assembly comprises the steps of:
pre-cleaning the workpieces in the process chamber with a cleaning solution to remove surface contamination;
chemically etching the workpieces in the process chamber with an etching fluid to thin the workpieces; and,
rinsing the workpieces in the process chamber.

51. The method of claim 50, wherein the step of conducting a pre-clean of the workpiece comprises applying a cleaning solution to the workpieces.

52. The method of claim 51, wherein the cleaning solution comprises at least one of H₂O, H₂O₂ and NH₄OH.

53. The method of claim 50, wherein the step of chemically etching the workpieces in the carrier assembly comprises the steps of: conducting a coarse chemical etch of the workpieces in the process chamber and conducting a polish chemical etch of the workpieces in the process chamber.

54. The method of claim 53, wherein an etch rate of the coarse chemical etch is greater than an etch rate of the polish chemical etch.

55. The method of claim 50, wherein the step of chemically etching the workpieces comprises applying a solution of HF, HNO₃ and H₃PO₄ to the workpiece.

56. The method of claim 50, wherein the step of rinsing the workpieces comprises applying a solution of H₃PO₄ to the workpieces in the process chamber.

57. A system for chemically thinning a batch of semiconductor workpieces, the system comprising:
a plurality of workpiece stations, with at least one station having an apparatus comprising:
a process chamber having a chamber body having a first end, a second end, an outer wall, and an opening at the first end leading into a cavity, the process chamber having a vent to vent vapors from the cavity of the process chamber, the vent extending from proximal the first end of the chamber body to proximal the second end of the chamber body, the process chamber also having a drain trough to drain process fluid from the cavity of the process chamber, the drain trough extending from proximal the first end of the chamber body to proximal the second end of the chamber body;
a carrier for holding a plurality of the workpieces, the workpieces being retained about a peripheral portion of the workpieces, and the carrier being positioned in the cavity of the process chamber;
a door assembly adjacent the first end of the chamber body, the door assembly having a door that selectively closes the opening of the chamber body;
a motor connected to the chamber body to rotate the carrier and the workpieces therein; and,
a spray assembly associated with the process chamber, the spray assembly having a nozzle to spray a process fluid into the cavity of the chamber body and onto the semiconductor workpiece to thin the workpiece.

58. The system of claim 57, further comprising a rotor assembly supporting the carrier, the rotor assembly having a drive member that is coupled to the motor, the motor providing rotational motion to the drive member to rotate the rotor assembly.

59. The system of claim 58, wherein the carrier has a plurality of positioning members, wherein the workpieces are retained between the positioning members of the carrier, and wherein the carrier is positioned within the rotor assembly.

60. The system of claim 57, further comprising mounting members of the process chamber which mate with receiving members of the cabinet to support the process chamber at an incline in the cabinet.

61. The system of claim 57, wherein the spray assembly extends from generally adjacent the first end of the chamber body to a distance proximal the second end of the chamber body, and wherein the spray manifold has two inlet ports provided at opposing ends of the spray manifold.

62. The system of claim 61, wherein the spray assembly further comprises a second spray manifold having a plurality of nozzles, the second spray manifold has two inlet ports at opposing ends of the second manifold.

63. The system of claim 57, wherein the door assembly further comprises a linear actuator guide about which the door moves from a first closed position to a second open position.

64. The system of claim 57, where at least another one station has an apparatus comprising a secondary process chamber.

65. The system of claim 64, wherein the secondary process chamber comprises a drying and rinsing chamber to dry and rinse the workpieces after they have been thinned.

66. The system of claim 57, further comprising a delivery tank in fluid communication with the process chamber, the delivery tank housing a volume of the process fluid.

67. The system of claim 66, wherein the process fluid comprises at least one of water, hydrogen peroxide, ozone, potassium hydroxide, sodium hydroxide, hydrofluoric acid, nitric acid, sulfuric acid, acidic acid and phosphoric acid.

68. The system of claim 66, further comprising a recirculation system in fluid communication with the exit port and the delivery tank to communicate process fluid from the process chamber to the delivery tank.
